(19) United States
(12) Patent Application Publication
(10) Pub. No.: US 2024/0213642 A1
(43) Pub. Date: Jun. 27, 2024

(54) APPARATUS AND SYSTEM FOR SPLITTING AND COMBINING SIGNALS IN THE FREQUENCY DOMAIN

(71) Applicant: Nokia Shanghai Bell Co., Ltd., Shanghai (CN)

(72) Inventors: Gildas BENGLOAN, Nantes (FR); Denis TUAU, Trignac (FR); Jose ENRIQUEZ GONZALEZ, Nazaire (FR)

(73) Assignee: Nokia Shanghai Bell Co., Ltd., Shanghai (CN)

(21) Appl. No.: 18/538,288

(22) Filed: Dec. 13, 2023

(30) Foreign Application Priority Data
Dec. 22, 2022 (FI) 20226151

(51) Int. Cl. H01P 1/213; H01P 1/161; H01P 1/17; H01P 3/123; H01P 5/19

(52) U.S. Cl. CPC H01P 1/2138; H01P 1/161; H01P 1/171; H01P 3/123; H01P 5/19

(57) ABSTRACT

In one embodiment, a waveguide structure, disposed between a first waveguide port and second and third waveguide ports, is configured to split, in the frequency domain, the first signal into the second and third signals, and/or combine, in the frequency domain, the second and third signals into the first signal. The waveguide structure includes an asymmetric cross-sectional shape defining first and second aperture regions having respective first and second extents, wherein the second extent is less than the first extent. The waveguide structure is arranged relative to the second and third waveguide ports such that the third waveguide port is predominantly adjacent the first aperture region, and the second waveguide port is predominantly adjacent the second aperture region.

### TECHNOLOGICAL FIELD

Examples of the present disclosure relate to an apparatus and system for splitting and combining signals in the frequency domain. Some examples, though without prejudice to the foregoing, relate to a waveguide junction for splitting and combining signals in the frequency domain and a diplexer comprising the same.

### BACKGROUND

Conventional waveguide junctions for splitting and combining signals in the frequency domain (e.g. splitting a first signal, in the frequency domain, into a second signal and a third signal; and/or combining, in the frequency domain, second and third signals into a first signal), for use in a diplexer, are not always optimal.

Conventional waveguide junctions for a diplexer for effecting frequency domain splitting and combination of signals (such as an H-plane or E-plane T-junction) are known. However, such conventional waveguide junctions typically additionally require the use of a filter, which adds to the size, and weight, of the overall waveguide assembly and diplexer formed therefrom.

In some circumstances it can be desirable to provide a waveguide junction that enables a compact duplexing solution. In some circumstances it can be desirable to provide a waveguide junction that avoids the need for a filter (a “filter-less waveguide). In some circumstances it can be desirable to provide a frequency splitting waveguide junction that enables a first signal having a (wide) first frequency band to be split into second and third signals of a particular/selected (narrow) second and third frequency bands which are sub-bands of the first frequency band. In some circumstances it can be desirable to provide a frequency combining waveguide junction that enables second and third signals of a particular/selected second and third frequency bands, which are sub-bands of a first frequency band, to be combined into a first signal having the first frequency band. In some circumstances it can be desirable to provide a frequency splitting/combining waveguide junction that provides flexibility regarding the adjustment of the fractional bandwidth of each frequency sub-band into which a signal is split into or combined from. In some circumstances it can be desirable simplify the manufacture/machining of a waveguide junction (and hence reduce production costs).

The listing or discussion of any prior-published document or any background in this specification should not necessarily be taken as an acknowledgement that the document or background is part of the state of the art or is common general knowledge. One or more aspects/examples of the present disclosure may or may not address one or more of the background issues.

### BRIEF SUMMARY

The scope of protection sought for various embodiments of the invention is set out by the claims.

According to various, but not necessarily all, examples of the disclosure there are provided examples as claimed in the appended claims. Any examples and features described in this specification that do not fall under the scope of the independent claims are to be interpreted as examples useful for understanding various embodiments of the invention.

According to at least some examples of the disclosure there is provided an apparatus comprising:
a first waveguide port for supporting a first signal, wherein the first waveguide port is configured to have a first frequency band of operation;
a second waveguide port for supporting a second signal, wherein the second waveguide port is configured to have a second frequency band of operation that is a sub-band of the first frequency band of operation;
a third waveguide port for supporting a third signal, wherein the third waveguide port is configured to have a third frequency band of operation that is a sub-band of the first frequency band of operation and that is higher than the second frequency band of operation;
a waveguide structure, disposed between the first waveguide port and the second and third waveguide ports, configured to:
   split, in the frequency domain, the first signal into the second and third signals, and/or
   combine, in the frequency domain, the second and third signals into the first signal;
wherein the waveguide structure comprises an asymmetric cross-sectional shape defining:
   a first aperture region having a first extent, and
   a second aperture region having a second extent less than the first extent; and
wherein the waveguide structure is arranged relative to the second and third waveguide ports such that:
   the third waveguide port is predominantly adjacent the first aperture region, and
   the second waveguide port is predominantly adjacent the second aperture region.

According to various, but not necessarily all, examples of the disclosure there is provided a waveguide junction, a diplexer, an OrthoMode Transducer or an antenna system comprising the apparatus.

According to various, but not necessarily all, examples of the disclosure there is provided a method of providing and/or manufacturing an apparatus and/or system as described herein.

According to various, but not necessarily all, examples of the disclosure there is provided a method of using an apparatus and/or system as described herein.

The following portion of this ‘Brief Summary’ section describes various features that can be features of any of the examples described in the foregoing portion of the ‘Brief Summary’ section. The description of a function should additionally be considered to also disclose any means suitable for performing that function.

In some but not necessarily all examples:
the first signal has a first polarisation state,
the second and third signals have a second polarisation state, and
the waveguide structure is configured to rotate the polarisations of the signals between the first and second polarisation states.

In some but not necessarily all examples, the third waveguide port is configured to have a cut-off operational frequency that is higher than an upper frequency the operational frequency band of the second waveguide port.

In some but not necessarily all examples, the waveguide structure is arranged at an oblique angle relative to one or more of the waveguide ports.

In some but not necessarily all examples:
the cross-sectional shape of the waveguide structure is elongate defining a longitudinal axis of the waveguide structure;
the cross-sectional shape of the second or third waveguide port is elongate defining a longitudinal axis of the second or third waveguide port;
the waveguide structure is arranged relative to the second or third waveguide port such that the longitudinal axis of the waveguide structure is at a predetermined angle to the longitudinal axis of the second or third waveguide port; and
the predetermined angle is at least one or more of:
   an oblique angle,
   an angle between 25 to 45 degrees,
   an angle of approximately 35 degrees, and
   an angle of approximately 45 degrees.

In some but not necessarily all examples, a length of a diagonal of the cross-sectional shape of the waveguide structure is greater than or equal to a width of the first and/or second waveguide ports.

In some but not necessarily all examples, the waveguide structure comprises one or more ridges configured to select a frequency at which the first signal is split in the frequency domain.

In some but not necessarily all examples, the waveguide structure comprises one or more spline-based shapes configured to enhance the RF performance of the apparatus.

In some but not necessarily all examples:
the waveguide structure comprises a substantially H-shaped structure,
a first side of the H-shaped structure is wider than a second side of the H-shaped structure,
the first side of the H-shaped structure defines the first aperture region, and
the second side of the H-shaped structure defines the second aperture region.

In some but not necessarily all examples, the second and third waveguide ports are arranged parallel to one another.

In some but not necessarily all examples, the second and third waveguide ports have a separation distance approximately equal to 1/16^{th} of a wavelength of an upper frequency of the third frequency band of operation.

In some but not necessarily all examples, wherein the apparatus a waveguide junction.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION OF THE DRAWINGS

Some examples will now be described with reference to the accompanying drawings in which:

FIG. 1 shows an example of the subject matter described herein;

FIG. 2 shows another example of the subject matter described herein;

FIGS. 3A, 3B and 3C show other examples of the subject matter described herein;

FIGS. 4A and 4B show other examples of the subject matter described herein;

FIGS. 5A and 5B show other examples of the subject matter described herein;

FIG. 6 shows another example of the subject matter described herein;

FIG. 7 shows another example of the subject matter described herein;

FIG. 8 shows another example of the subject matter described herein;

FIG. 9 shows another example of the subject matter described herein;

FIG. 10 shows another example of the subject matter described herein;

FIG. 11 shows another example of the subject matter described herein;

FIG. 12 shows another example of the subject matter described herein;

FIG. 13 shows another example of the subject matter described herein;

FIG. 14 shows another example of the subject matter described herein;

FIG. 15 shows another example of the subject matter described herein;

FIG. 16 shows another example of the subject matter described herein;

FIG. 17 shows another example of the subject matter described herein; and

FIG. 18 shows another example of the subject matter described herein.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

In the drawings (and description) a similar feature may be referenced by the same three-digit number. In the drawings (and description), an optional subscript to the three-digit number can be used to differentiate different instances of similar features. Therefore, a three-digit number without a subscript can be used as a generic reference and the three-digit number with a subscript can be used as a specific reference. A subscript can comprise a single digit that labels different instances. A subscript can comprise two digits including a first digit that labels a group of instances and a second digit that labels different instances in the group.

### DETAILED DESCRIPTION

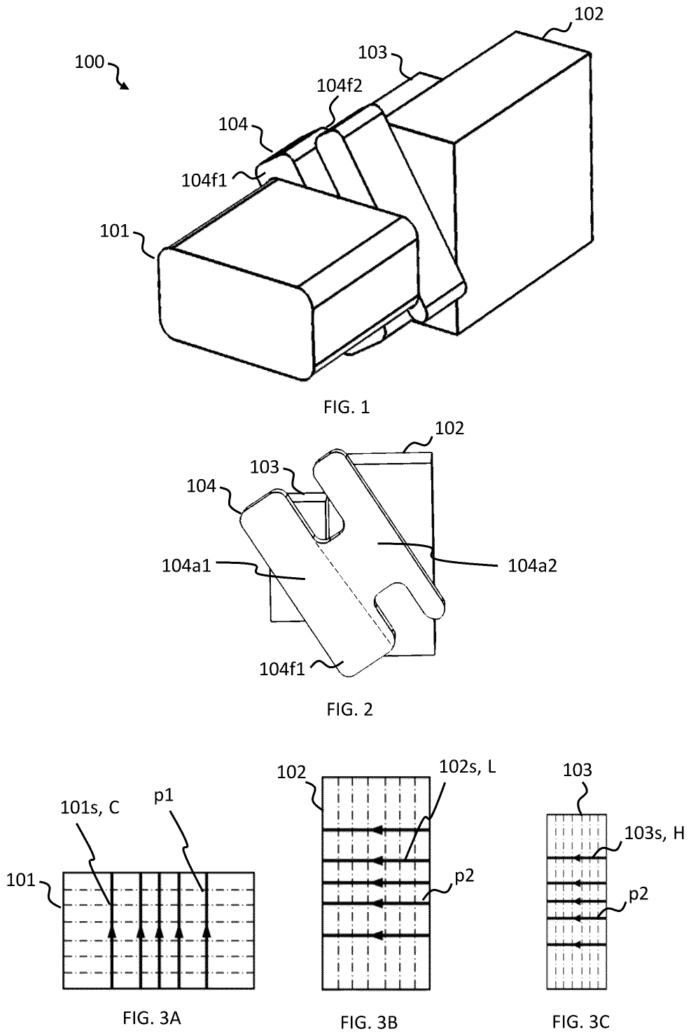

FIG. 1 shows a perspective view of an example of an apparatus 100 according to the present disclosure.

The apparatus is a wave guide component, such as a waveguide junction for splitting/combining Radio Frequency, RF, signals in the frequency domain. The apparatus comprises: a first waveguide port 101, a second waveguide port 102 and a third waveguide port 103; each of which is substantially aligned in the same direction (i.e. are substantially parallel to one another—as compared to a T-junction where a first port is at right angles for a second and a third port).

The apparatus also comprises a waveguide structure 104 that is disposed between the first waveguide port and the second and third waveguide ports.

The first waveguide port 101 serves as an input/output, I/O, port for supporting a first signal 101s (see FIG. 3A). The first waveguide port is configured to have a first frequency band of operation. In this regard, the first waveguide port may be dimensioned so as to have a frequency band of operation that corresponds to the first frequency band. In this example, the first signal, which may also be referred to as a common signal “C”, is a wideband signal having a frequency band that corresponds to the first frequency band.

The second waveguide port 102 serves as an input/output, I/O, port for supporting a second signal 102s (see FIG. 3B). The second waveguide port is configured to have a second frequency band of operation, wherein the second frequency band of operation is a sub-band of the first frequency band of operation. In this example, the second signal, which may also be referred to as a low signal “L”, is a narrow signal having a frequency band that corresponds to a lower sub-band portion of the first frequency band.

The third waveguide port 103 serves as an input/output, I/O, port for supporting a third signal 103s (see FIG. 3C). The third waveguide port is configured to have a third frequency band of operation, wherein the third frequency band of operation is a sub-band of the first frequency band of operation and is different to the second frequency band of operation. In this example, the third signal, which may also be referred to as a high signal “H”, is a narrow signal having a frequency band that corresponds to a higher sub-band portion of the first frequency band.

FIG. 1 (and the other figures) represent the waveguide ports (and waveguide sections) as 3D hollow structures.

The waveguide structure 104 comprises first and second opposing faces 104f1 and 104f2. The waveguide structure is sandwiched between the ports such that the first face is disposed adjacent the first port, and the second face is adjacent the second and third waveguide ports.

The waveguide structure 104 is a hollow waveguiding structure that is configured to:
split, in the frequency domain, the first signal into the second and third signals, and/or
combine, in the frequency domain, the second and third signals into the first signal.

The waveguide structure 104 serves as a frequency selector and frequency splitter (i.e. selecting the frequency at which the first signal is split) which separates one wide frequency band from one rectangular waveguide towards two different rectangular waveguides operating each one with a new frequency sub band. The new frequency sub bands do not have to be the same in terms of fractional bandwidth. The waveguide structure provides flexibility regarding the adjustment of the fractional bandwidth for each new frequency sub band. The apparatus also enables frequency discrimination (i.e. low and high bands in the second and third waveguide ports) without the use of a filter.

FIG. 2 shows a front-on end view of the apparatus 100 but wherein, for clarity, the first port is not shown.

As is more clearly shown in this figure, the waveguide structure has an asymmetric cross-sectional shape (i.e. the waveguide structure is a asymmetric cross-sectional hollow shape) which comprises/definiens:

a first aperture region (104a1) having a first extent/size, and
a second aperture region (104a2) having a second extent/size less than the first extent—i.e. the first aperture region is larger than the second aperture region.

In this regard, the dimensions of the first aperture region are larger than those of the second aperture region such that the extent/size of the first aperture region defines a larger contiguous cross-sectional area than that of the second aperture region.

In the example of FIG. 2, the first aperture region can be considered as the portion of the waveguide structure on one side of the waveguide structure (in this example to the left of the illustrated bisecting dotted line—i.e. the upper and lower limbs/legs of the left hand side of the H-shaped structure), and the second aperture region can be considered as the portion of the waveguide structure on this other side (i.e. to the right of the bisecting dotted line which corresponds to the upper and lower limbs/legs of the right hand side of the H-shaped structure).

The example of the waveguide structure of FIGS. 1 and 2 consists of a central waveguide shaped like an H, with rounded corners and one side (a left side defining the first aperture region) thicker than the other side (the right side defining the second aperture region). This allows a low frequency sub-band to be directed through the wider part of the H, and a high frequency sub-band through the thinner part of the H. In addition, the waveguide structure is oriented at an angle, e.g. 45°, to urge the polarized wave towards the output waveguide ports. One or more inclusions or ridged shapes can also be used to adapt each frequency band. It is to be appreciated that the length and width of each ridges can be optimized (e.g. using a genetic algorithm) in order to enhance the splitting effect of the waveguide structure and control/adjust/select the frequency at which the common signal is split.

The waveguide structure is arranged (i.e. configured/disposed/orientated) relative to the second and third waveguide ports such that:
the third waveguide port (for the H signal) is predominantly adjacent the first aperture region, and
the second waveguide port (for the L signal) is predominantly adjacent the second aperture region.

In this regard, the waveguide structure is configured such that the majority of its larger first aperture region overlies/lies in front of the smaller third waveguide port, and the majority of the waveguide structure's smaller second aperture region overlies/lies in front of the larger second waveguide port. In other words, more of the larger first aperture region overlies the smaller third waveguide port than the larger second waveguide; and likewise more of the smaller second aperture region overlies the larger second waveguide port than the smaller first waveguide port.

The first waveguide port is substantially coaxially aligned with the waveguide structure, i.e. their centres/centroids are substantially aligned with one another. The second and third waveguide ports are arranged so that their respective centres/centroids are as close to the centre/centroid of the waveguide structure as possible.

As shown in FIGS. 3A-3C, the first signal 101s, C has a first polarisation state p1 (e.g. vertically polarised E-field), whereas the second and third signals 102s, L and 103s, H have a second polarisation state p2 (e.g. horizontally polarized E-field—at 90º to p1).

The first waveguide port 101 may be a rectangular waveguide supporting a TE10 mode and the propagation of a first signal 101s, C having a vertical polarisation p1. The first waveguide port is configured to have a first frequency cut off, e.g. 4.75 Ghz, that is chosen to transmit a RF signal over a wide frequency band (e.g. between 5.5 GHZ and 9 GHZ)—of course other frequencies could be selected.

The second waveguide port 102 may be a rectangular waveguide supporting a TE10 mode and the propagation of a second signal 102s, L having a horizontal polarisation p2. The second waveguide port may have a second frequency cut off the same as or close to that of the first waveguide port, e.g. 4.5 GHZ (of course other frequencies could be selected), and it is configured to convey a lower frequency sub-band as compared to the third waveguide port. The second waveguide port is thereby associated with conveying low-band LB signals.

The third waveguide port 103 may be a rectangular waveguide supporting a TE10 mode and the propagation of a third signal 103s, H having a horizontal polarisation p2. The third waveguide port may have a third frequency cut off that is higher than an upper frequency of the operational frequency band of the second waveguide port, e.g. 7.25 GHZ (of course other frequencies could be selected) and it is configured to convey a higher frequency sub-band as compared to the second waveguide port. The third waveguide port is thereby associated with conveying high-band HB signals.

The dimensions of the three waveguide ports/waveguide just before and after the H-shape waveguide structure (i.e. the frequency splitter) also affect the frequency splitting functionality. In particular, the smaller waveguide 103 impacts the high frequency sub-band selection.

The waveguide structure is configured to rotate the polarisations of the signals between the first and second polarisation states. In effect, the waveguide structure may serve as a polarisation rotator and also as a frequency splitter. In this regard, the first wideband signal C, input via the first waveguide port and having a vertical polarisation, undergoes 90° polarisation rotation and frequency splitting via the waveguide structure resulting in: a second signal L output via the second waveguide port, and a third signal H output via the third waveguide port—both having a horizontal polarisation. For the reciprocal case, a second signal L input via the second waveguide port, and a third signal H input via the third waveguide port, both having a horizontal polarisation, undergo 90° polarisation rotation and combination via the waveguide structure resulting in a first wideband signal C having a vertical polarisation output via the first waveguide port.

In essence, the wave guide structure can be considered as being a 90° polarisation rotator albeit with substantial modifications, namely in relation to its shape (not least its asymmetric shape with differing sized aperture portions and the use of ridges as discussed further below), as well as its respective positioning and alignment with respect to first, second and third waveguide ports.

Conventional polarisation rotators only direct one polarisation at a time. In examples of the present apparatus, two TE10 polarisations on two rectangular waveguides 102 and 103 operating in two different frequency bands are directed to from a single TE10 signal propagating in a common rectangular waveguide 101.

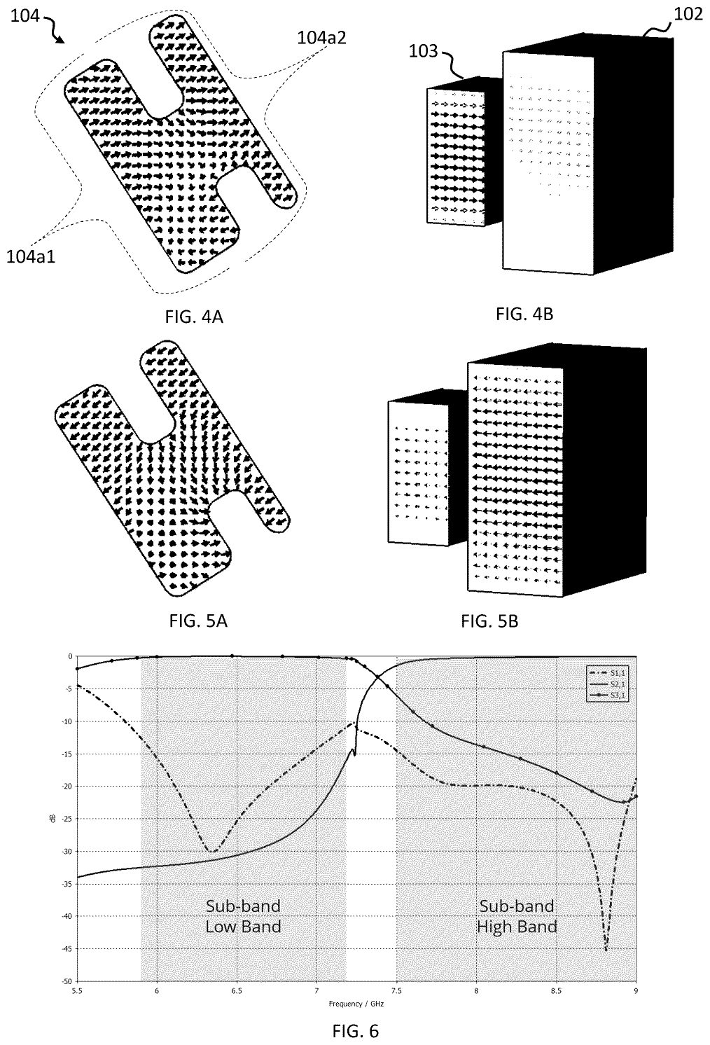

FIGS. 4A and 4B, and 5A and 5B schematically illustrate simulations of E-field distribution in the waveguide structure 104 (FIGS. 4A and 5A, respectively at a low band mid frequency point and a high band mid frequency point) and the second and third wave guide ports (FIGS. 4B and 5B, respectively at a low band mid frequency point and a high band mid frequency point). These FIGS. show that the high and low frequency sub-bands are correctly split and conveyed to the low and high band waveguide ports (i.e. the second and third waveguide ports) depending on the signal frequency.

FIGS. 4A and 4B schematically illustrate the E-filed distribution at a low band mid frequency point (e.g. 6.425 GHZ). As shown, almost all the signal is transmitted in the LB waveguide port 102 by virtue of the cut-off frequency of the HB waveguide port 103.

FIGS. 5A and 5B schematically illustrate the E-filed distribution at a high band mid frequency point (e.g. 8.1 GHZ). Here, the signal is rightly transmitted in the HB waveguide 103. Nevertheless, a small part of the high band signal might propagate inside the LB waveguide 102 as its cut-off frequency does allow signal propagation at this frequency.

FIG. 6 illustrate simulation results (simulated S-parameters) which show that a first signal is well split into two sub-bands: one from 5.9 GHZ to 7.2 GHZ, and the other from 7.5 GHZ to 9 GHz. Whilst these performances may not be optimal, they do show the functionality and feasibility of the waveguide structure in effecting signal splitting. As will be discussed below, the waveguide structure can be modified/improved to enhance its Return Loss, RL, characteristics.

The waveguide structure's shape is not limited to an ‘H’ based shape. Various configurations are possible.

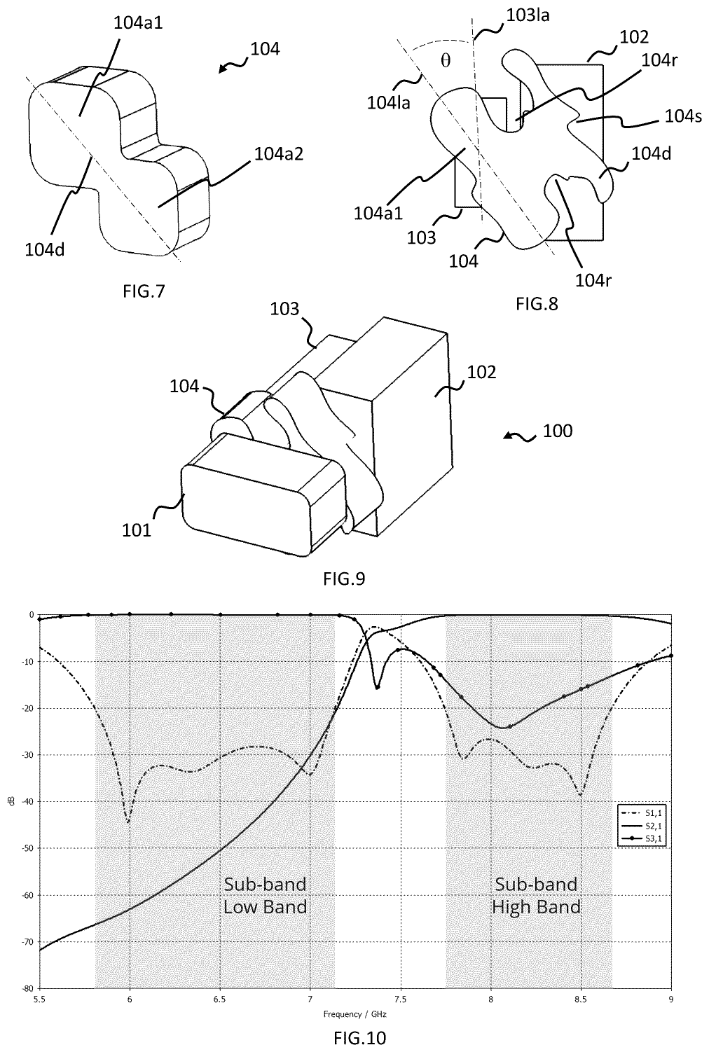

FIG. 7 illustrates an example of an alternatively shaped waveguide structure 104, namely in the form of two offset square-rounded waveguide sections. The waveguide structure again has an asymmetric shape, with a first aperture region 104a1 being larger in extent/size than a second aperture region 104a2. One key point of the design is the length of the diagonal(s) 104d, this/these must be large enough to allow a wave to rotate (i.e. the diagonals must be equal to or wider than the widest waveguide port (e.g. the width of the first or second waveguide ports). In addition, the cross-sectional shape of the waveguide structure could be modified so as to include one or more a genetic algorithm-based curves or splines in order to add smoothness in the shape of the wave guide structure and thus enhance the bandwidth. The location of the one or more spline-based shapes within the waveguide structure and/or one or more dimensions of the one or more spline-based shapes can be optimised to enhance the RF performance.

FIG. 8 illustrates a further example of a waveguide structure 104, which is based on an H-shape albeit with enhancements. In this example, the H-shaped waveguide structure has been optimized to improve its RF performance (improvement of Return Loss, Insertion Loss and Inter-band Rejection). To achieve this, the H-shape is modified by using spline-based shapes (random analytic curves).

The waveguide structure is arranged at an oblique angle (θ) relative to the third and second waveguide ports (which are parallel to one another). In this regard, one may consider that the cross-sectional shape of the waveguide structure is elongate defining a longitudinal axis of the waveguide structure. Likewise, the cross-sectional shape of the second or third waveguide port is elongate defining a longitudinal axis of the second or third waveguide port. The waveguide structure is arranged relative to the second or third waveguide port such that the longitudinal axis of the waveguide structure is at a predetermined angle (θ) to the longitudinal axis of the second or third waveguide port, wherein the redetermined angle may be an oblique angle, such as between 25 to 45 degrees, an angle of approximately 35 degrees, or an angle of approximately 45 degrees.

FIG. 9 shows another example of an apparatus 100 comprising the waveguide structure 104 of FIG. 8 sandwiched between the first waveguide port 101 and the second and third waveguide ports 102 and 103 (wherein such waveguide ports may correspond to those as discussed above, i.e. with the second waveguide port being configured to convey LB frequency signals and the third waveguide port being configured to convey HB frequency signals, wherein the LB and HB are sub bands of a frequency band supported by the first waveguide port).

The use of random analytic curves may allow more efficient selection/discrimination of frequency sub-bands. They may also improve the return loss of the apparatus. Indeed, the rounded shapes may permit a smoother propagation of the signal in the apparatus and reduce the risk of lowering the Return Loss figure.

Examples of the disclosure may use a waveguide structure with a variable shape, optimized by means of a genetic algorithm. The shape of the waveguide structure can be square, round, rectangular, or randomly parametrized. Various simulations performed by the inventors have established that different waveguide structure shapes can work, by reusing existing polarization rotators structures, such as a bone-shape rotator (i.e. similar to FIG. 7). It has been found that optimal results are obtained using spline-based H shapes (such as in FIG. 8. The optimized shape remains easily machinable, resulting in lower cost with standard machining process.

Hence, an optimal waveguide structure may be an extruded H-shaped waveguide, whose diagonal is wider than the width of the largest waveguide port. A theta rotation of 35°+10° with respect to a vertical axis (or 55°+10° with respect to a horizontal axis) from the common rectangular waveguide is applied in order to get an optimal frequency operation.

Unlike all other types of waveguide junctions used for frequency splitting (i.e. T-junction, Y-junction), the apparatus of examples of the present disclosure allows all the waveguides ports to be put in the same direction (instead of a right angle often encountered in the state of the art). This may significantly reduce a size of the apparatus and device (e.g. diplexer/OMT/antenna system comprising the apparats). Furthermore, unlike other waveguide junctions; advantageously, waveguide junctions in accordance with the present disclosure do not require any kind of filter.

FIG. 10 illustrates simulation results for the apparatus/waveguide junction of FIG. 9. This shows that a common signal is well split into two sub-bands: the first from 5.8 GHz to 7.14 GHz, and the second from 7.74 GHZ to 8.67 GHZ. The Return Loss of the apparatus/waveguide junction has been significantly improved as compared to that of the apparatus/waveguide junction of FIG. 1, better than 25 dB over almost all the sub-bands which demonstrates an excellent performance of the apparatus/waveguide junction of FIG. 9.

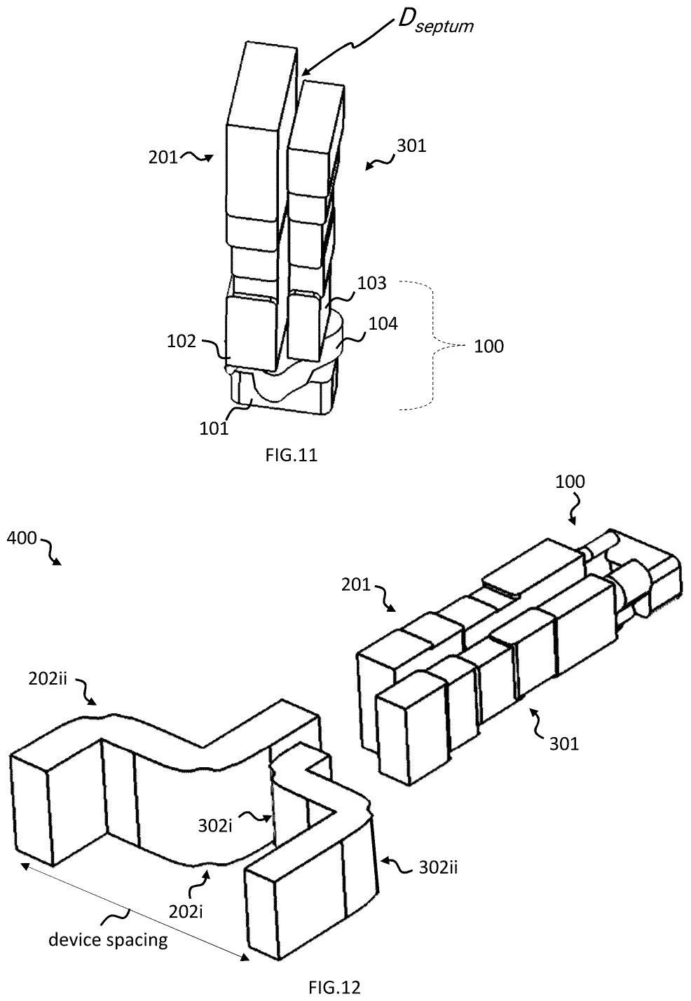

FIG. 11 shows the apparatus 100 along with further waveguiding components that are comprised in first and second waveguide pathways 201, 301. The first and second waveguide pathways respectively convey the L frequency sub-band signal and the H frequency sub-band signal to/from the second and third waveguide ports 102 and 103 respectively. FIG. 11 also shows that there is a separation distance between the second and third ports (and likewise between the first and second radio pathways) referred to as a septum distance, Dₛₑₚₜᵤₘ.

In order to be able to connect standard size waveguides to each waveguide pathway, additional radio paths are required after the apparatus 100. Stepped impedance waveguide sections 201 and 301 are added for the low and high bands, to obtain waveguide sizes matching with, for example R84_W112 and R70_WR137 standards. These waveguide sections, made of quarter wavelength impedance transformers, also improve the rejection between the frequency bands. Thereby also improving a RL of a whole frequency divider system (i.e. which comprises the apparatus and waveguide pathways).

A specific parameter Dₛₑₚₜᵤₘ corresponds to a distance between the two waveguides right after the waveguide structure 104 (i.e. a separation distance between the second and third ports). The value of Dₛₑₚₜᵤₘ is determined so as to satisfy multiple criteria:
Radioelectrical criterion. Dₛₑₚₜᵤₘ value is optimized to obtain an optimal frequency split effect. If the distance between the second and third waveguides ports is too short or too wide, the frequency split might be less effective, resulting in low RL performance.
Machining criterion. Dₛₑₚₜᵤₘ value must be large enough to allow the device to be machined. If the distance is less than 1 mm, it becomes difficult to manufacture the device considering its mechanical resistance, as well as the machining tolerance.

Choosing a high value for Dₛₑₚₜᵤₘ while keeping the RF constraints is advantageous, especially at low frequencies (below 10 GHZ). Following this, it will be easier to redesign the device by scaling at higher frequencies without being constrained by machining limitations.

The inventors have determined, after simulations, an optimal value of Dₛₑₚₜᵤₘ (to obtain the criteria established above) is about one sixteenth of the guided wavelength λg at the desired frequency. The guided wavelength λg may correspond to an upper frequency of the higher sub-band (i.e. Dₛₑₚₜᵤₘ may be approximately equal to 1/16th of a wavelength of an upper frequency of the third frequency band of operation). In some examples, Dₛₑₚₜᵤₘ IS as small as possible while still allowing for machining. However, one-sixteenth of a guided wavelength relative to the upper frequency of the higher sub-band has been found to be an optimal compromise.

In a frequency splitting mode of operation, once the frequency splitting has been carried out, i.e. via the waveguide structure 104, each split signal (L and H) is conveyed through impedance matching made by λ/4 (being λ the free space wavelength) transformer sections of each radio pathway adapted for each frequency sub-band. As discussed above, this is done to increase the RF rejection between the frequency sub-bands. Also, it enables an adjustment of the dimensions of each radio pathway's waveguide so as to enable connection to standard size waveguides.

Additional components are required to space the first and second waveguide pathways from each other, and to allow connection of RF measurement equipment. For this purpose, genetic-algorithm optimized right angle waveguides can be used for High band and Low band operation. They are optimized to present a best possible RL. They also allow some design flexibility to get the correct spacing of the device without lowering the RF performance.

A general view of the frequency splitter junction followed by the step impedance waveguides and the right-angle waveguides is illustrated FIG. 12.

FIG. 12 shows the apparatus 100 along with right angle waveguides that are comprised in first and second waveguide pathways 201, 301. The further waveguiding components of each waveguide pathway 201, 301 comprise two 90° elbows (i.e. a pair of 90° elbows for each waveguide pathway: 202i & 202ii, and 302i & 302ii. Two such elbows are provided to each radio pathway in order to adjust/regulate the distance between the two output ports (i.e. adjust the spacing of the device so as to enable the device to be connectable with standard size waveguides).

A center distance to connect waveguide, which corresponds to the spacing of the device, is controlled by the length of the right-angle waveguides. Hence, it is possible to shorten or lengthen the device spacing depending on the mechanical constraints of the environment.

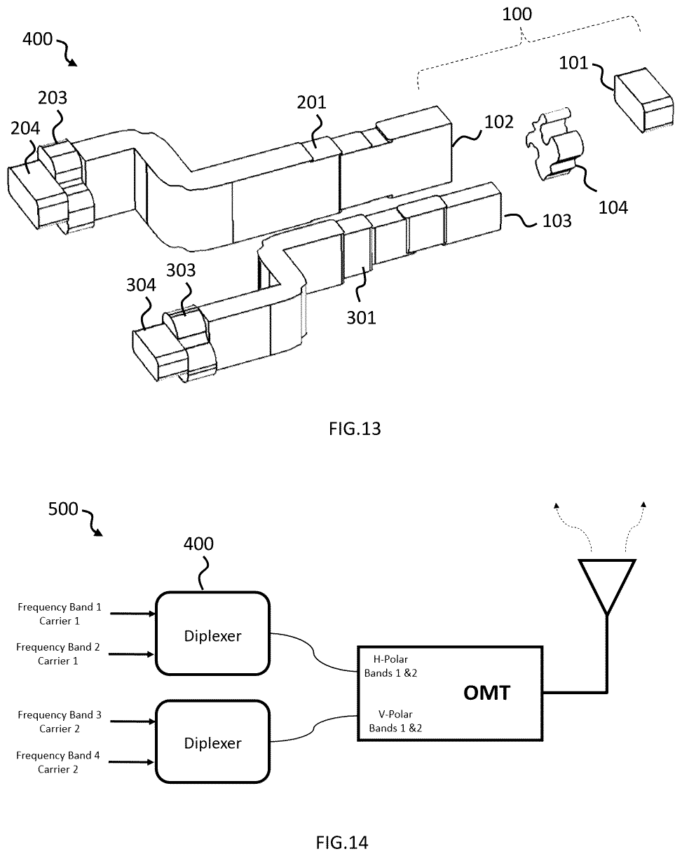

FIG. 13 shows the device of FIG. 12 further with a 90° polarization rotator per frequency sub band, 203 and 303, to re-orient the final waveguide section/ports 204 and 304 so as to be in the same direction as the common rectangular waveguide port 101. The performance of each rotator is set to maximize the RL on each defined sub-band.

The multiplication of telecommunication standards in recent years, and the increasing capacity of point-to-point wireless links, require a growing number of high-performance multi-band antennas. In order to optimize the deployed radio resources, the combination of several channels on a single antenna allows to reduce deployment costs and environmental impact of radio networks. The use of dual polarized and dual-band antennas increases the capacity and quality of service (QOS) of a network due to the opportunity to cover multiple frequency bands. This dual-band feature of an antenna is enabled by the mean of a diplexing solution (i.e. splitting two different frequency bands of operation). A dual-polarized dual-band antenna solution is a way for reducing the tower leasing cost, installation time and for lightening the tower structure.

The system 400 may provide a filter-less waveguide frequency splitter solution for an antenna providing high radiofrequency performances. The system acts like a compact diplexing solution, easily adjustable for every targeted frequency bands.

The system 400 may provide a filter-less waveguide frequency splitter that embodies two functions, namely a waveguide junction and a filtering solution, of a common diplexing solution in one element.

The filter-less waveguide frequency splitter 400 has a similar architecture to certain conventional diplexers references, excepting that it does not contain/use any filter or tuning procedure. It consists of a frequency splitter junction (apparatus 100) and radio paths for each frequency sub-band 201, 301 (including straight and elbow waveguide sections) that are optimized to minimize the overall footprint of the device and enhance the RF performance.

A stepped impedance waveguide is used per frequency sub-band to adjust the dimensions of the output guides and to enhance the rejection between frequency sub-bands.

A signal of the common port 101 conveys both low band and high band frequencies. When arriving in the apparatus/splitter junction 100, the two frequency sub-bands are split in the LB and HB waveguides 201 and 301 respectively so low band frequency is redirected at one port 102 and high frequency band at the other RF port 103.

Two 90° polarisation rotators 203 and 303 (which may be optimized to be thinner than existing solutions), are integrated into the system 400. Each polarisation rotator allows a RF signal guided in a rectangular waveguide to be rotated in its polarization direction in TE10 mode over a wide frequency band. Here, a TE10 mode signal propagated in the waveguide of each radio pathway is rotated using the 90° polarisation rotator to an orthogonal waveguide port 204.

The rotation requires two rectangular guides separated by a variable shape component (e.g. bone shaped component for each of 203 and 303) shown here as two rounded squares. This shape allows a smooth and gradual rotation of the electric field from one waveguide to the other, resulting in a wide operating bandwidth and satisfactory S-parameters performance. Indeed, simulations show the 90° polarisation rotator exhibiting a 30 dB simulated Return Loss over a 20% bandwidth (5.8 GHZ-7.4 GHZ).

The system 400 of FIG. 13 may form a diplexer 400 (such as may be used with an Otho-Mode Transducer of dual polarized and dual-band antenna system 500 as shown in FIG. 14 and discussed below).

FIG. 14 shows a dual band, dual polarization antenna system 500 which comprises a broadband and/or dual-band antenna feed, an Orthomode Transducer (OMT) and two diplexers (i.e. as per the system 400 of FIG. 13). Each diplexer splits, in the frequency domain, a radio frequency (RF) signal operating in a wide frequency band into two different and narrow frequency bands (and vice versa as a diplexer has the same RF properties transmitting or receiving). One of the diplexers is associated with a Vertical polarization and the other diplexer is associated with the Horizontal polarization, FIG. 14.

The multiplication of devices required to operate such a system 500 increases the weight and complexity of the installation. Indeed, traditional diplexer solutions include filters whose size is inversely proportional to the operating frequency. Thus, for low-frequency radio frequency antenna links, the diplexers take up a lot of space, and the increased weight to the system becomes non-negligible (about twenty cm and a few kilos).

FIG. 15 illustrates a manufacturing solution for the individual parts of the system of FIG. 13. Of course, it is to be appreciated that manufacture of the parts can be realized by other methods, not least such as additive manufacturing or sintering.

The simplicity and compactness of the system of FIG. 13 (as well as other examples of the present disclosure) permit the manufacturing, by classical machining, of the system in only two distinct layers, i.e. the bottom and top part of the waveguide pathways (as per the: top left and top centre images) that can be assembled together with the remaining unit elements, i.e. the splitter junction; Low Band output port; and High Band output port (as per the: top right, bottom left and bottom centre images) to form the overall assembled filter-less waveguide frequency splitter system 400 (as per the bottom right image).

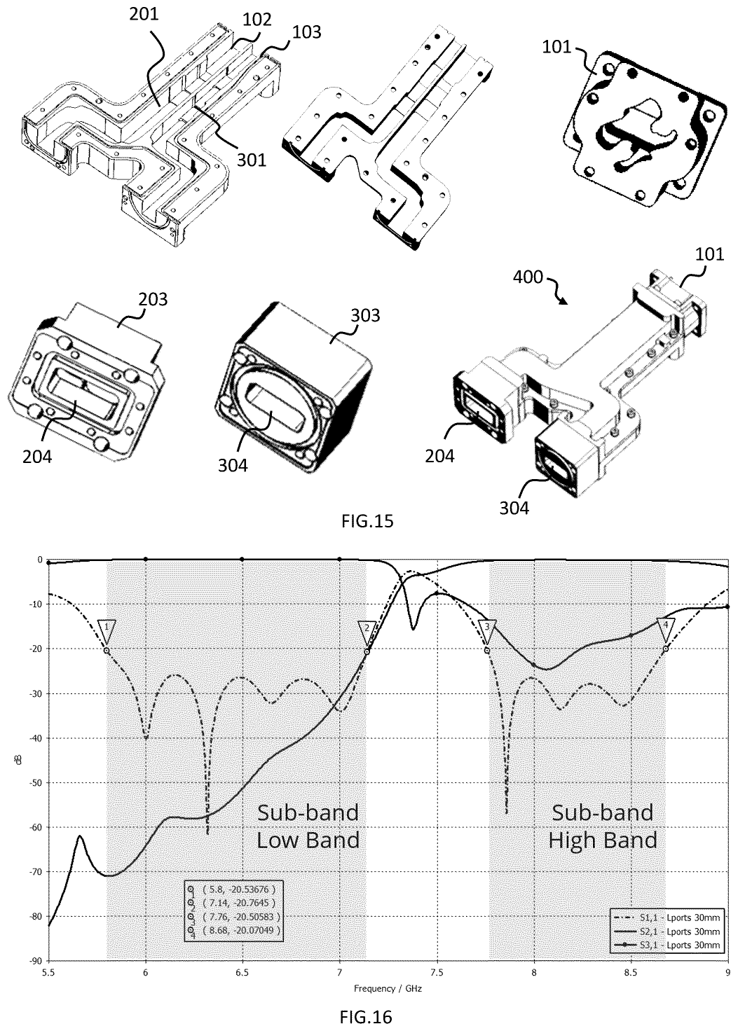

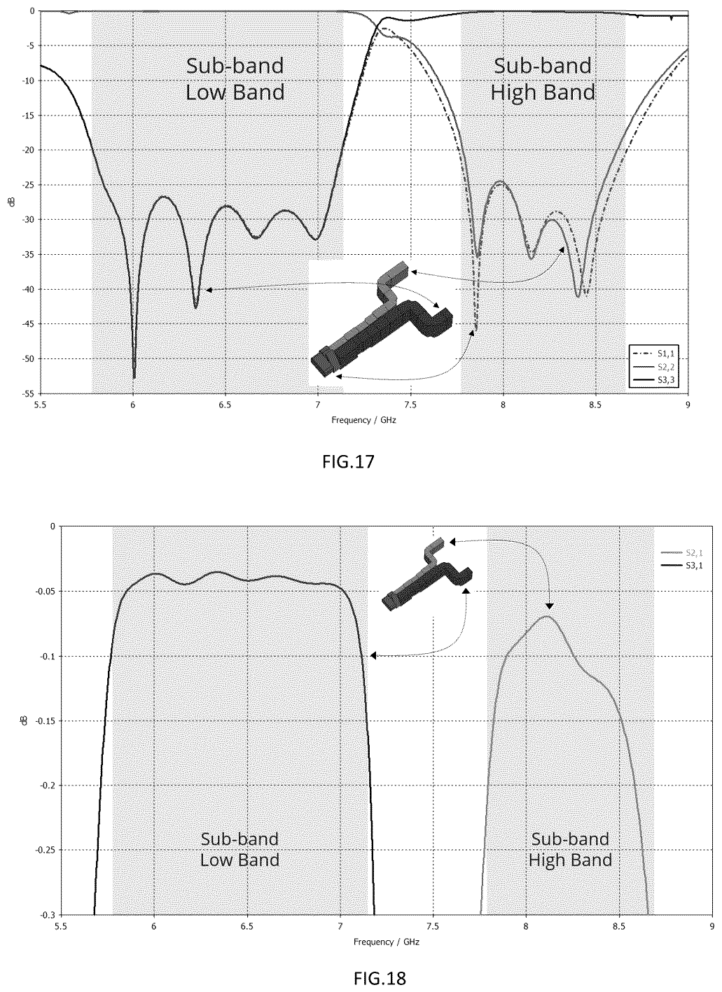

FIG. 16 a plot of simulated S-parameters of the filter-less waveguide frequency splitter system. This shows that the system's return loss in operating microwave frequency bands having a return loss value better than 20 dB on both the low sub band and high sub band channels.

In the simulation, the frequency splitter system operates a sub-band separation between 5.8 GHz and 7.14 GHZ (23% relative bandwidth) for the lower band, and between 7.76 GHZ and 8.68 GHZ (12% relative bandwidth) for the higher band.

Due to the inherent cut off frequency of the high frequency band rectangular waveguide of the splitter junction, a good rejection is obtained in the lower band of operation. The rejection values start from 20 dB to 72 dB. The rejection values in the high band start from 15 dB to 25 dB. Moreover, an aim of examples of filter-less waveguide frequency splitter systems according to the present disclosure is to achieve a frequency band separation rather than necessarily a good rejection, as the latter can be provided by an upstream Outdoor Unit (ODU).

FIG. 17 illustrates a plot of simulated reflection coefficients at each port of the filter-less waveguide frequency splitter system:
1: common port,
2: high band port, and
3: low band port.

This confirms that the filter-less waveguide frequency splitter system works properly.

FIG. 17 illustrates a plot of simulated Insertion Loss, IL, for each port of the filter-less waveguide frequency splitter system, taking into account Aluminium conductor as material, roughness 0.8 μm, FIG. 19. This shows excellent IL values, better than 0.05 dB for the lower band and 0.2 dB for the higher band.

Compared to conventional diplexers and frequency division solutions, examples of frequency splitting junctions and diplexers according to the present disclosure are more flexible as they do not rely on/require T-junction or Y-junction dimensioning and filter design (and hence examples can be narrower/have a reduced device separation distance). Also, instead of designing and optimising plural specific elements, examples are based on a single component: the frequency splitter/selector junction (i.e. apparatus 100). Knowing that only the dimensioning of the junction is mandatory, one can quickly and easily modify a frequency band of operation, especially since only the cut-off frequency must be calculated for the high band (i.e. the third waveguide port).

As the frequency discrimination operation is done by a unique element (i.e. apparatus 100), the design of a frequency splitting junction may be more compact than existing solutions. Furthermore, there is no tuning process needed with any external assembly part (such as tuning screws for example). Examples of the present disclosure may thereby provide an improved frequency splitting/selecting junction that may give rise to advantages in reducing device size, weight, and manufacturing time (and hence costs).

One advantage of examples of the present disclosure is that, due to its compactness, it can be used in combination with other devices. For example, in the use case shown in FIG. 14, examples can be used in association with an OMT to reduce the number of devices and the complexity of the overall antenna system.

Examples of the disclosures may provide technical advantages in that they may:
Remove the need to use filters to carry out the required frequency splitting.
Reduce the complexity of the RF device
Reduce the size and weight of the frequency splitting solution
Simplify the machining process and reduce the manufacturing costs
Reduce the impact on the Insertion Loss due to filter design (enhancing the antenna gain and Backhaul radio link performance)
Suppress any external RF tuning process inherent with the filter technology.

Although specific terms are employed herein, they are used in a generic and descriptive sense only and not for purposes of limitation. Features described in the preceding description can be used in combinations other than the combinations explicitly described.

Although functions have been described with reference to certain features, those functions can be performable by other features whether described or not.

Although features have been described with reference to certain examples, those features can also be present in other examples whether described or not. Accordingly, features described in relation to one example/aspect of the disclosure can include any or all of the features described in relation to another example/aspect of the disclosure, and vice versa, to the extent that they are not mutually inconsistent.

Although various examples of the present disclosure have been described in the preceding paragraphs, it should be appreciated that modifications to the examples given can be made without departing from the scope of the invention as set out in the claims.

The term ‘comprise’ is used in this document with an inclusive not an exclusive meaning. That is any reference to X comprising Y indicates that X can comprise only one Y or can comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e. so as to provide direct or indirect connection/coupling/communication. Any such intervening components can include hardware and/or software components.

In this description, reference has been made to various examples. The description of features or functions in relation to an example indicates that those features or functions are present in that example. The use of the term ‘example’ or ‘for example’, ‘can’ or ‘may’ in the text denotes, whether explicitly stated or not, that such features or functions are present in at least the described example, whether described as an example or not, and that they can be, but are not necessarily, present in some or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class.

In this description, references to “a/an/the” [feature, element, component, means . . . ] are used with an inclusive not an exclusive meaning and are to be interpreted as “at least one” [feature, element, component, means . . . ] unless explicitly stated otherwise. That is any reference to X comprising a/the Y indicates that X can comprise only one Y or can comprise more than one Y unless the context clearly indicates the contrary. If it is intended to use ‘a’ or ‘the’ with an exclusive meaning then it will be made clear in the context. In some circumstances the use of ‘at least one’ or ‘one or more’ can be used to emphasise an inclusive meaning but the absence of these terms should not be taken to infer any exclusive meaning. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The presence of a feature (or combination of features) in a claim is a reference to that feature (or combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described. In the above description, the apparatus described can alternatively or in addition comprise an apparatus which in some other examples comprises a distributed system of apparatus, for example, a client/server apparatus system. In examples where an apparatus provided forms (or a method is implemented as) a distributed system, each apparatus forming a component and/or part of the system provides (or implements) one or more features which collectively implement an example of the present disclosure. In some examples, an apparatus is re-configured by an entity other than its initial manufacturer to implement an example of the present disclosure by being provided with additional software, for example by a user downloading such software, which when executed causes the apparatus to implement an example of the present disclosure (such implementation being either entirely by the apparatus or as part of a system of apparatus as mentioned hereinabove).

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavouring in the foregoing specification to draw attention to those features of examples of the present disclosure believed to be of particular importance it should be understood that the applicant claims protection in respect of any patentable feature or combination of features hereinbefore referred to and/or shown in the drawings whether or not particular emphasis has been placed thereon.

The examples of the present disclosure and the accompanying claims can be suitably combined in any manner apparent to one of ordinary skill in the art. Separate references to an “example”, “in some examples” and/or the like in the description do not necessarily refer to the same example and are also not mutually exclusive unless so stated and/or except as will be readily apparent to those skilled in the art from the description. For instance, a feature, structure, process, block, step, action, or the like described in one example may also be included in other examples, but is not necessarily included.

Each and every claim is incorporated as further disclosure into the specification and the claims are embodiment(s) of the present disclosure. Further, while the claims herein are provided as comprising specific dependencies, it is contemplated that any claims can depend from any other claims and that to the extent that any alternative embodiments can result from combining, integrating, and/or omitting features of the various claims and/or changing dependencies of claims, any such alternative embodiments and their equivalents are also within the scope of the disclosure.

1. An apparatus comprising:
a first waveguide port for supporting a first signal, wherein the first waveguide port is configured to have a first frequency band of operation;
a second waveguide port for supporting a second signal, wherein the second waveguide port is configured to have a second frequency band of operation that is a sub-band of the first frequency band of operation;
a third waveguide port for supporting a third signal, wherein the third waveguide port is configured to have a third frequency band of operation that is a sub-band of the first frequency band of operation and that is higher than the second frequency band of operation;
a waveguide structure, disposed between the first waveguide port and the second and third waveguide ports, configured to,
split, in the frequency domain, the first signal into the second and third signals, and/or
combine, in the frequency domain, the second and third signals into the first signal;
wherein the waveguide structure comprises an asymmetric cross-sectional shape defining,
a first aperture region having a first extent, and
a second aperture region having a second extent less than the first extent; and
wherein the waveguide structure is arranged relative to the second and third waveguide ports such that,
the third waveguide port is predominantly adjacent the first aperture region, and
the second waveguide port is predominantly adjacent the second aperture region.

2. The apparatus of claim 1, wherein:
the first signal has a first polarisation state,
the second and third signals have a second polarisation state, and
the waveguide structure is configured to rotate the polarisations of the signals between the first and second polarisation states.

3. The apparatus of claim 1, wherein the third waveguide port is configured to have a cut-off operational frequency that is higher than an upper frequency the operational frequency band of the second waveguide port.

4. The apparatus of claim 1, wherein the waveguide structure is arranged at an oblique angle relative to one or more of the waveguide ports.

5. The apparatus of claim 1, wherein:
the cross-sectional shape of the waveguide structure is elongate defining a longitudinal axis of the waveguide structure;
the cross-sectional shape of the second or third waveguide port is elongate defining a longitudinal axis of the second or third waveguide port;
the waveguide structure is arranged relative to the second or third waveguide port such that the longitudinal axis of the waveguide structure is at a predetermined angle to the longitudinal axis of the second or third waveguide port; and
the predetermined angle is at least one or more of:
an oblique angle,
an angle between 25 to 45 degrees,
an angle of approximately 35 degrees, and
an angle of approximately 45 degrees.

6. The apparatus of claim 1, wherein a length of a diagonal of the cross-sectional shape of the waveguide structure is greater than or equal to a width of the first and/or second waveguide ports.

7. The apparatus of claim 1, wherein the waveguide structure comprises one or more ridges configured to select a frequency at which the first signal is split in the frequency domain.

8. The apparatus of claim 1, wherein the waveguide structure comprises one or more spline-based shapes configured to enhance the RF performance of the apparatus.

9. The apparatus of claim 1, wherein:
the waveguide structure comprises a substantially H-shaped structure,
a first side of the H-shaped structure is wider than a second side of the H-shaped structure, the first side of the H-shaped structure defines the first aperture region, and
the second side of the H-shaped structure defines the second aperture region.

10. The apparatus of claim 1, wherein the second and third waveguide ports are arranged parallel to one another.

11. The apparatus of claim 1, wherein the second and third waveguide ports have a separation distance approximately equal to 1/16^{th} of the wavelength of an upper frequency of the third frequency band of operation.

12. The apparatus of claim 1, wherein the apparatus a waveguide junction.

13. A diplexer comprising the apparatus of claim 1.

14. An OrthoMode Transducer, OMT, comprising the apparatus of claim 1.

15. An antenna system comprising the apparatus of claim 1.
